(19) United States
(12) Patent Application Publication
(10) Pub. No.: US 2026/0066600 A1
(43) Pub. Date: Mar. 5, 2026

(54) CONDUCTOR WIRE CONNECTION METHOD, HALF-STRIPPING JIG, CONNECTION DEVICE, AND ELECTRONIC DEVICE

(71) Applicant: Proterial, Ltd., Tokyo (JP)

(72) Inventors: Kenichi TAMURA, Tokyo (JP); Takumi KOBAYASHI, Tokyo (JP); Ryuta TAKAHASHI, Tokyo (JP); Yuki ITO, Tokyo (JP)

(73) Assignee: Proterial, Ltd., Tokyo (JP)

(21) Appl. No.: 19/288,293

(22) Filed: Aug. 1, 2025

(30) Foreign Application Priority Data
Aug. 27, 2024 (JP) 2024-146006
Apr. 11, 2025 (JP) 2025-065852

(51) Int. Cl. H01R 43/02; H01R 4/02; H02G 1/12

(52) U.S. Cl. CPC H01R 43/0249; H01R 4/023; H01R 4/026; H01R 4/027; H01R 43/0263; H02G 1/1256; H02G 1/128

(57) ABSTRACT

A method for connecting a conductor wire to an electrode that is formed on a substrate includes placing the conductor wire on the electrode while tension is applied to the conductor wire, and soldering the conductor wire to the electrode while the conductor wire is pressed toward the substrate by a heating element.

### CROSS-REFERENCE TO RELATED APPLICATIONS

The present patent application claims the priority of Japanese patent application No. 2024-146006 filed on Aug. 27, 2024 and the priority of Japanese patent application No. 2025-065852 filed on Apr. 11, 2025, and the entire contents thereof are hereby incorporated by reference.

### TECHNICAL FIELD

This invention relates to a conductor wire connection method for connecting a conductor wire to an electrode formed on a substrate, a half-stripping jig for exposing a conductor wire partially in the longitudinal direction of an insulated coated wire, a connection device having the half-stripping jig, and an electronic device in which a plurality of conductor wires are connected to a plurality of electrodes on a substrate.

### BACKGROUND OF THE INVENTION

Conventionally, in some electronic devices that are required to be compact such as medical catheters to be inserted into the human body, conductor wires are respectively soldered to a plurality of electrodes formed in a narrow pitch on a substrate. Methods for soldering conductor wires to a plurality of electrodes formed at a narrow pitch are described, for example, in Patent Literatures 1 and 2.

In the method described in Patent Literature 1, a plurality of ultrafine multicore cables are aligned on a substrate on which a rectangular-shaped solid pad is formed, the center conductors of the ultrafine multicore cables are soldered to the solid pad, and then between the center conductors are cut together with the solid pad by irradiating a laser beam. In the method described in Patent Literature 2, a plurality of insulated coated wires are aligned along a predetermined alignment direction, the insulation coating is removed partially in the longitudinal direction of each insulated coated wire to expose a core wire, and the core wires are respectively soldered to electrode pads on a substrate, while applying tension to the plurality of insulated coated wires in the longitudinal direction.

### CITATION LIST

### Patent Literatures

Patent Literature 1: JP2003-180015A

Patent Literature 2: JP2022-189648A

### SUMMARY OF THE INVENTION

In the method according to Patent Literature 1, if the center conductor bends largely on the solid pad due to twisting tendency (i.e., residual twist) of the center conductor, the length of a part of the center conductor soldered to the solid pad after cutting may become shorter. In the method according to Patent Literature 2, a gap corresponding to at least the thickness of the insulation coating is created between the substrate and the core wire, although the bending of the core wire can be reduced by the tension applied to the insulated coated wire. Therefore, there was a restriction that cream solder had to be applied to a thickness greater than the thickness of the insulation coating, for example.

For the above reason, it is an object of the present invention to provide a conductor wire connection method that enables easy and reliable soldering of conductor wires to electrodes on a substrate. The present invention also provides a half-stripping jig for exposing a conductor wire partially in the longitudinal direction of an insulated coated wire in which the conductor wire is covered with an insulator, a connection device with the half-stripping jig, and an electronic device having a substrate on which a plurality of electrodes is formed and a plurality of conductor wires which is soldered to the plurality of electrodes.

In order to achieve the above-mentioned object, one aspect of the present invention provides a conductor wire connection method for connecting a conductor wire to an electrode that is formed on a substrate, comprising:
placing the conductor wire on the electrode while tension is applied to the conductor wire; and
soldering the conductor wire to the electrode while the conductor wire is pressed toward the substrate by a heating element.

Further, in order to achieve the above-mentioned object, another aspect of the present invention provides a half-stripping jig for collectively half-stripping a plurality of insulated wires each having a conductor wire coated with an insulator, comprising:
a pair of comb-shaped elements with a plurality of slits,
wherein a width of each of the plurality of slits is larger than a diameter of the conductor wire and smaller than an outer diameter of the insulator, and
wherein the conductor wires are exposed between the pair of comb-shaped elements by separating the pair of comb-shaped elements along a longitudinal direction of the plurality of conductor wires, in a state where the conductor wires are inserted into the plurality of slits respectively.

Still further, in order to achieve the above-mentioned object, a still another aspect of the present invention provides a connection device, comprising:
the half-stripping jig according to claim 10; and
a heating element that presses and solders a plurality of the conductor wires inserted between the pair of comb-shaped elements to a plurality of the electrodes respectively.

Furthermore, in order to achieve the above-mentioned object, a further aspect of the present invention provides an electronic device, comprising:
a substrate in which a plurality of electrodes are formed and a plurality of conductor wires are soldered to the plurality of electrodes respectively,
wherein each tip of the plurality of conductor wires is curved so that it is raised from the substrate.

### Advantageous Effects of the Invention

According to the conductor wire connection method of the present invention, it is possible to easily and securely solder the conductor wires to the electrodes on the substrate. Also, according to the half-stripping jig and the connection device of the present invention, the conductor wires can be easily exposed from insulators and soldered even if the conductor wires are covered with the insulators. In addition, the electronic device allows manufacturing by soldering the plurality of conductor wires to the plurality of electrodes on the substrate while applying tension to the conductor wires to keep them pressed against the electrodes. As a result, the conductor wires can be easily and securely soldered to the electrodes on the substrate.

### BRIEF DESCRIPTION OF THE DRAWINGS

FIG. 1A is a perspective view showing a part of an electronic device according to an embodiment of the present invention.

FIG. 1B is a cross-sectional view taken along the line A-A of FIG. 1A.

FIG. 2A is a side view of one wire viewed from a direction perpendicular to the longitudinal direction.

FIG. 2B is a cross-sectional view of the wire.

FIG. 3 is a plan view of a substrate at the periphery of a plurality of electrodes.

FIG. 4 is a configuration diagram showing a pair of comb-shaped elements of a half-stripping jig to be used for the half-stripping step.

FIG. 5 is a perspective view showing a plurality of wires before the half-stripping step is performed.

FIG. 6 is a perspective view showing the first stage of the half-stripping step.

FIG. 7 is a perspective view showing the second stage of the half-stripping step.

FIG. 8 is a perspective view showing the third stage of the half-stripping step.

FIG. 9 is a cross-sectional view of the plurality of wires in the placing step together with a connection device.

FIG. 10 is a perspective view showing the substrate, a solder foil, a protective material, and the plurality of wires.

FIG. 11A is an explanatory diagram of the soldering.

FIG. 11B is a cross-sectional view taken along the line B-B of FIG. 11A.

FIG. 12A is an explanatory diagram of the removal step.

FIG. 12B is an explanatory diagram showing a blade tool, a moving member, a contact member, a support member, and a holding member used in the removal step.

FIG. 13A is a perspective view showing a heater chip as a heating element according to a modified example.

FIG. 13B is a perspective view showing the heater chip and the plurality of wires.

FIG. 14A and FIG. 14B are configuration diagrams showing the soldering using the heater chip according to the modified example and the connection device having a heater chip 70.

FIG. 15A is a cross-sectional view taken along the line C-C of FIG. 14A.

FIG. 15B is a cross-sectional view taken along at the line D-D of FIG. 14B.

FIG. 16 is a cross-sectional view of the conductor wires soldered to the electrodes on the substrate using the heater chip according to the modified example.

### DETAILED DESCRIPTION OF THE EMBODIMENT

### Embodiment

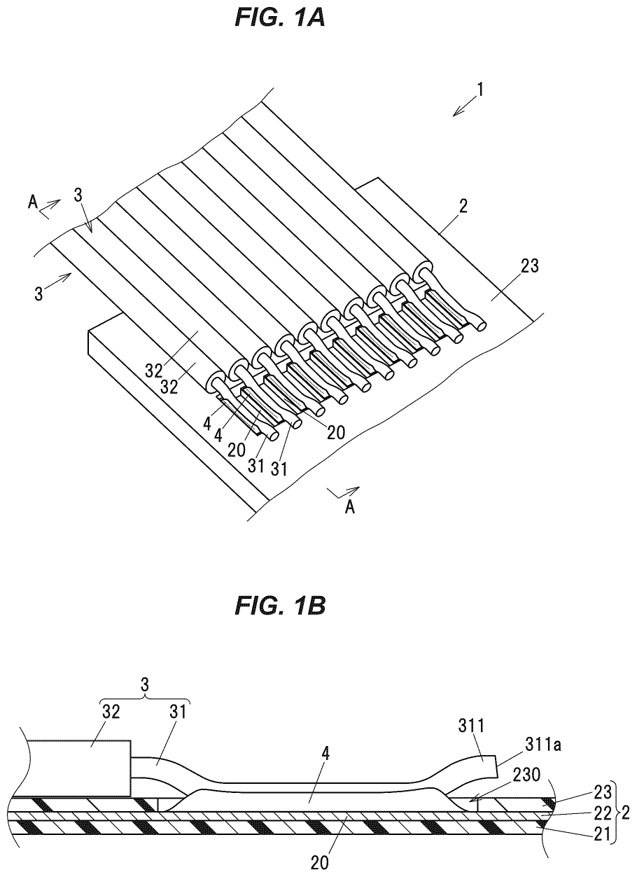

FIG. 1A is a perspective view showing a part of an electronic device according to an embodiment of the present invention. FIG. 1B is a cross-sectional view taken along the line A-A of FIG. 1A. An electronic device 1 is a product whose commercial value is enhanced by its high degree of integration and compact size, such as an endoscope or a wearable terminal, and has a substrate 2 and a plurality of electric wires 3.

A plurality of electrodes 20 is formed on the substrate 2. The electric wire 3 is an insulated electric wire having a conductor wire 31 and an insulator 32 that covers the conductor wire 31. The conductor wires 31 of the plurality of wires 3 are connected to the plurality of electrodes 20, respectively, by solder 4. In the present embodiment, 10 electrodes 20 are formed on the substrate 2, and the conductor wires 31 are soldered to the 10 electrodes 20 respectively. The substrate 2 is a flexible substrate having a flexible flat base material 21 such as polyimide, a conductive layer 22 in which a predetermined wiring pattern is formed, and a coverlay 23 covering the base material 21 and the conductive layer 22.

As shown in FIG. 1B, a tip 311 of each of the conductor wires 31 of the plurality of wires 3 is curved in such a way that it is raised from the substrate 2. Also, a tip surface 311a of each of the plurality of conductor wires 31 is located on the coverlay 23 of the substrate 2. Here, the tip 311 refers to a portion near the tip surface 311a in the conductor wires 31. The shape of the tip 311 of the conductor wires 31 allows the conductor wires 31 to be connected to the electrodes 20 by the connection method described below.

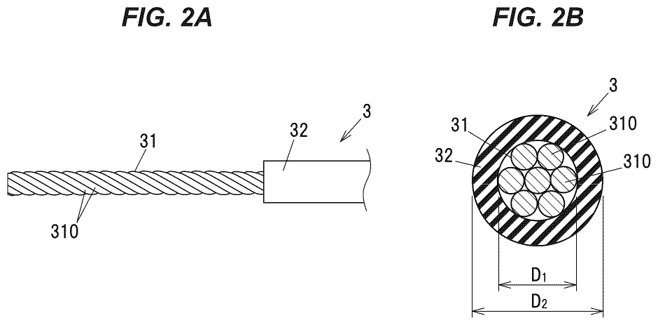

FIG. 2A is a side view of one electric wire 3 viewed from a direction perpendicular to the longitudinal direction. FIG. 2B is a cross-sectional view of the electric wire 3. The conductor wire 31 is made of copper or a copper alloy, for example. According to the present embodiment, the conductor wire 31 is a stranded wire consisting of a plurality of strands 310 twisted together in a spiral shape. However, the conductor wire 31 may be a single wire. In the example shown in FIG. 2A, seven strands 310 are twisted together to form the conductor wire 31, but the number of strands constituting the conductor wire 31 is not limited to this and may be six or less or eight or more. The insulator 32 is made of, for example, fluoroplastic or polyester resin. A conductor diameter D₁, which is the diameter of conductor wire 31, is, for example, from 0.02 mm to 0.10 mm (0.02 mm or more and 0.10 mm or less). An outer diameter D₂ of the insulator 32 is, for example, from 0.03 mm to 0.15 mm (0.03 mm or more and 0.15 mm or less). In FIG. 1A, FIG. 1B, and the drawings described below, the conductor wire 31 is shown as a single conductor, and the illustration of the strands 310 is omitted.

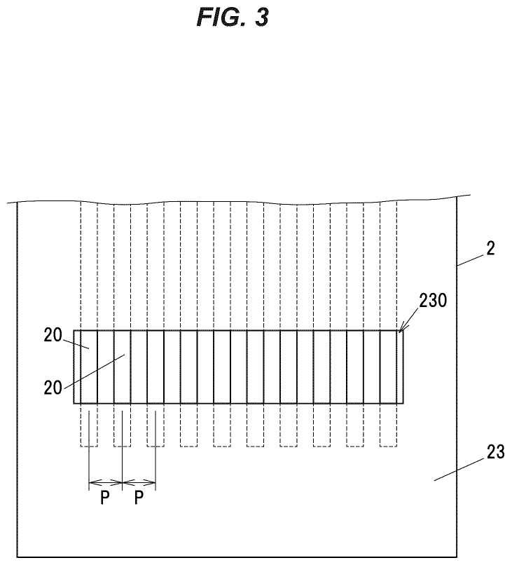

FIG. 3 is a plan view of the substrate 2 at the periphery of the plurality of electrodes 20. A rectangular aperture 230 is formed in the coverlay 23, and a portion of the conductive layer 22 exposed through the aperture 230 is the electrodes 20. The shape of each electrode 20 viewed from a direction perpendicular to the substrate 2 is a rectangular shape, which is long along the longitudinal direction of the electric wire 3. A pitch P of the plurality of electrodes 20 is, e.g., 0.20 mm or less. The conductive layer 22 electrically connects the plurality of conductor wires 31 to electronic components mounted on the substrate 2 but not shown. The electric wires 3 are connected to the electrodes 20 of the substrate 2, respectively, as signal lines to transmit electrical signals or as a power line to supply operating power to the electronic components.

Next, a connection method for connecting the conductor wires 31 to the electrodes 20 of the substrate 2 will be described. The connection method includes a half-stripping step of half-stripping a plurality of insulators 32 covering the plurality of conductor wires 31, a placing step of placing the plurality of conductor wires 31 in a tensioned state on the electrodes 20, a soldering step of soldering the conductor wires 31 to the electrodes 20 while the plurality of conductor wires 31 placed in the placing step are pressed against the substrate 2 by a heating element, and a removal step of removing the conductor wires 31 at the tip side of the electrodes 20 from the portion soldered to the electrodes 20. The half-stripping step is performed prior to the placing step. The removal step is performed after the soldering step. Here, “half-stripping” means exposing a part of the conductor wire 31 in the longitudinal direction from the insulator 32 while maintaining the state in which the end of the conductor wire 31 is covered by the insulator 32 before the placing step is performed.

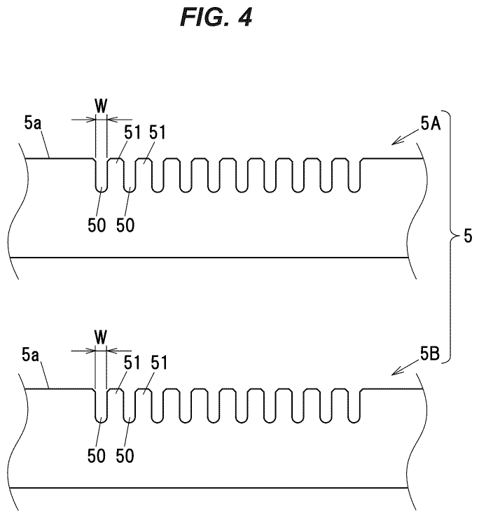

FIG. 4 is a configuration diagram showing a pair of comb-shaped elements 5A, 5B of a half-stripping jig 5 to be used in the half-stripping step. One comb-shaped element 5A and the other comb-shaped element 5B are configured in the same manner.

The comb-shaped elements 5A, 5B are flat plates in which a plurality of slits 50 are formed, and protrusions 51 are provided between a pair of adjacent slits 50. In the present embodiment, the comb-shaped elements 5A, 5B are rectangular in shape, and the slits 50 extend perpendicularly from one end face 5a in the short side direction to the long side direction. The width W of the slit 50 is larger than the conductor diameter D₁ of the conductor wire 31 and smaller than the outer diameter D₂ of the insulator 32.

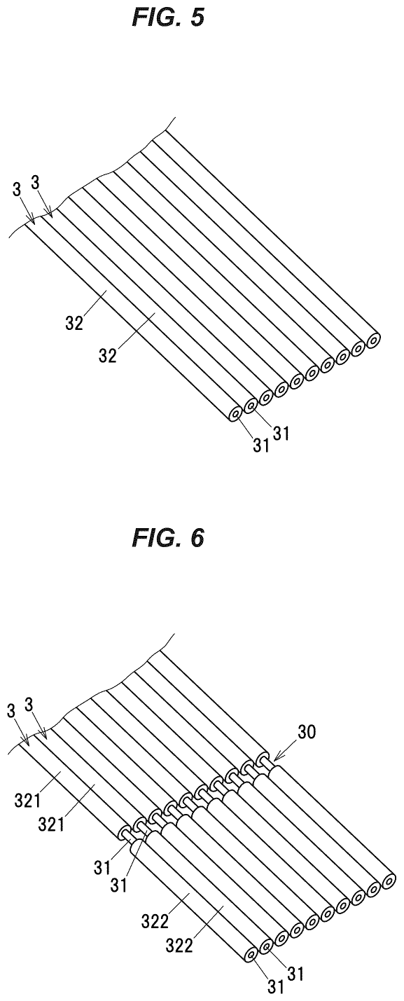

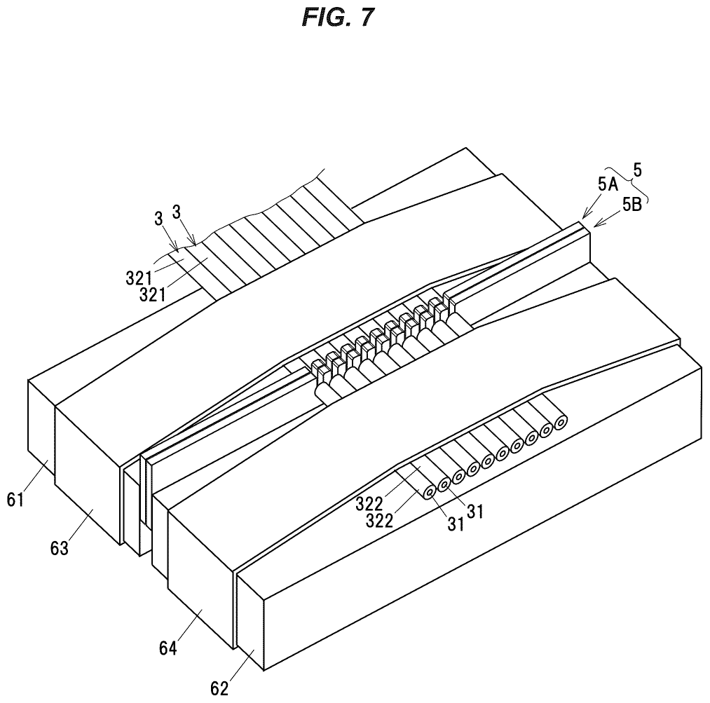

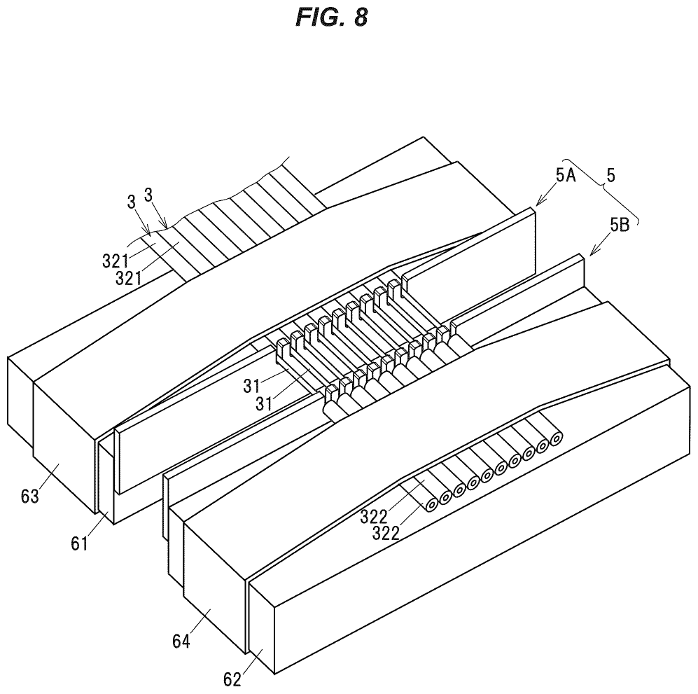

FIG. 5 is a perspective view showing the plurality of wires 3 before the half-stripping step is performed. FIG. 6 is a perspective view showing the first stage of the half-stripping step. FIG. 7 is a perspective view showing the second stage of the half-stripping step. FIG. 8 is a perspective view showing the third stage of the half-stripping step. In the present embodiment, the half-stripping step is performed with the pair of comb-shaped elements 5A, 5B fixed to supports 61, 62, respectively. The insulators 32 of the plurality of wires 3 are fixed to the supports 61, 62 by means of tapes 63, 64, respectively. The tapes 63, 64 serve as fixing members that fix the plurality of wires 3 to the supports 61, 62 at different positions in the longitudinal direction, respectively.

In the first stage of the half-stripping step, a portion of the insulator 32 of each of the plurality of wires 3 is removed to form a removed portion 30 by irradiating a laser beam. As this laser beam, a CO₂ laser beam emitted from a CO₂ laser source can be suitably used. In the second stage of the half-stripping step, the plurality of conductor wires 31 in the removed portion 30 are inserted into the plurality of slits 50 of the pair of comb-shaped elements 5A, 5B. In the third stage of the half-stripping step, the plurality of insulators 32 are half stripped and the conductor wires 31 are exposed between the pair of comb-shaped elements 5A, 5B by separating the pair of comb-shaped elements 5A, 5B along the longitudinal direction of the plurality of wires 3 in the state where the plurality of conductor wires 31 are inserted into the plurality of slits 50 of the pair of comb-shaped elements 5A, 5B.

In the first stage, the removed portion 30 divides the respective insulators 32 of the plurality of wires 3 into a first portion 321 and a second portion 322. In the second stage, a pair of comb-shaped elements 5A, 5B are placed between the first portion 321 and the second portion 322. In the third stage, the distance between the first portion 321 and the second portion 322 is widened by moving the comb-shaped element 5B relative to the comb-shaped element 5A. The distance between the pair of comb-shaped elements 5A, 5B when the half-stripping step is completed is shorter than the length of the second portion 322, and the conductor wires 31 are covered by the second portion 322 partially in the longitudinal direction.

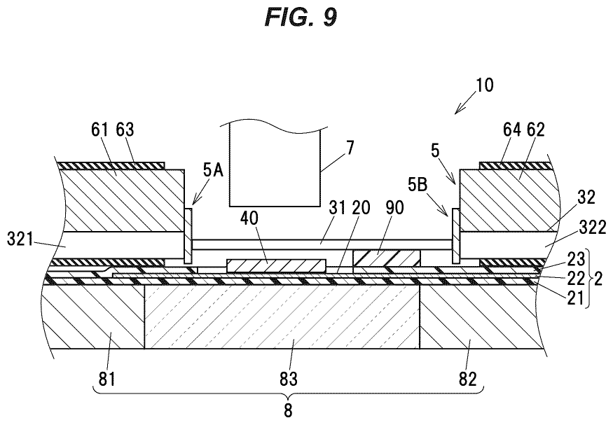

FIG. 9 is a cross-sectional view of the plurality of wires 3 in the placing step together with the connection device 10. In the placing step, the plurality of conductor wires 31 in a tensioned state between a pair of comb-shaped elements 5A, 5B are placed on the plurality of electrodes 20 of the substrate 2. In the placing step, each conductor wire 31 is covered by the insulator 32 on both sides in the longitudinal direction of the portion where the conductor wire 31 is soldered to the electrodes 20, and tension is applied to the conductor wire 31 by a frictional force between the conductor wire 31 and the insulator 32. This suppresses bending of the conductor wires 31 and straightens the conductor wires 31 between the pair of comb-shaped elements 5A, 5B.

The connection device 10 has the half-stripping jig 5 and supports 61, 62, a heater chip 7 as a heating element, and a support base 8. The support base 8 is, for example, composed of a first support base 81 and a second support base 82 that are made of metal, and a heat insulation base 83 that has higher heat resistance and insulation properties than the first support base 81 and the second support base 82. The heat insulation base 83 is made of heat-resistant glass, for example. The substrate 2 is placed on the support base 8 so that the plurality of electrodes 20 are positioned above the heat insulation base 83. The first portion 321 of the insulator 32 is positioned above the first support base 81 and the second portion 322 of the insulator 32 is positioned above the second support base 82.

In the placing step, solder foil 40 is placed between the plurality of electrodes 20 of the substrate 2 and the plurality of conductor wires 31 arranged between the pair of comb-shaped elements 5A, 5B, and at the same time, a protective material 90 is placed between the coverlay 23 of the substrate 2 and the plurality of conductor wires 31 arranged between the pair of comb-shaped elements 5A, 5B. The protective material 90 is made of resin or rubber, for example, and prevents the substrate 2 from being scratched during the removal step.

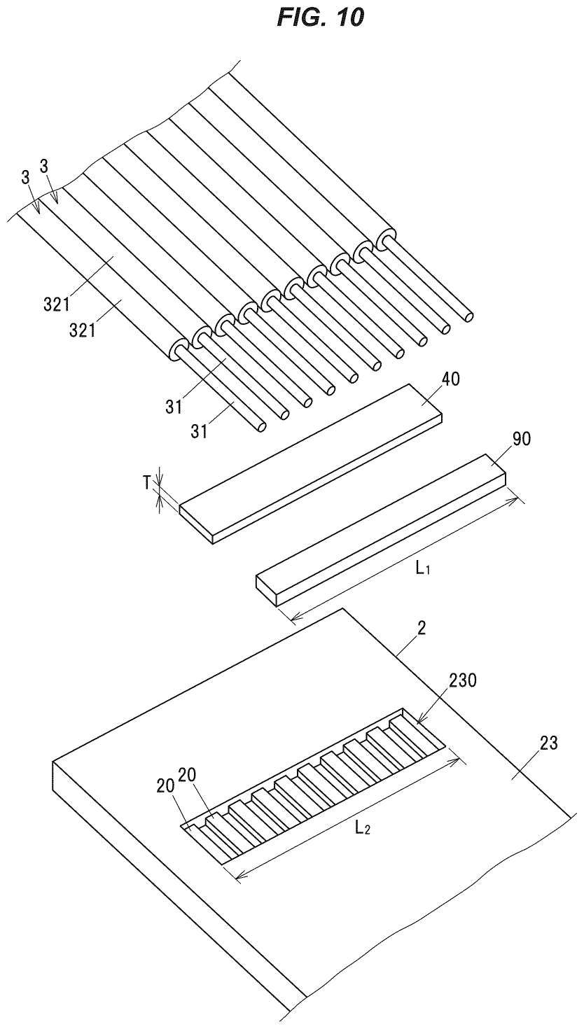

FIG. 10 is a perspective view showing the substrate 2, the solder foil 40, the protective material 90, and the plurality of wires 3 with the conductor wires 31 exposed. The solder foil 40 is about the same size as the aperture 230 of the coverlay 23, and its thickness T is, for example, 0.1 mm or less. The protective material 90 is disposed between the plurality of electrodes 20 and the second portion 322 of the insulator 32 in the longitudinal direction of the plurality of wires 3. Also, the protective material 90 is in the form of a strip extending in the alignment direction of the plurality of electrodes 20, and a length L₁ in the longitudinal direction is longer than a length L₂ of the aperture 230 of the coverlay 23 in the same direction.

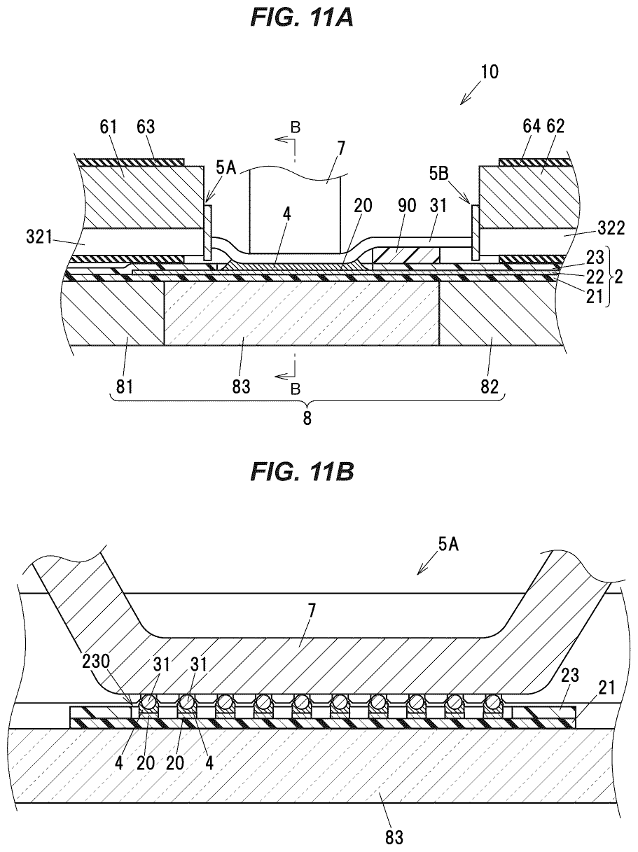

FIG. 11A is an explanatory diagram of the soldering step. FIG. 11B is a cross-sectional view taken along the line B-B of FIG. 11A. In the soldering step, a plurality of conductor wires 31 between a pair of comb-shaped elements 5A, 5B are pressed to the plurality of electrodes 20 collectively by the heater chip 7. The heater chip 7 generates heat by being energized to melt the solder foil 40. Some of the melted solder attaches to the coverlay 23 and the base material 21, but since the coverlay 23 and base material 21 repel the melted solder, the melted solder adheres to the electrodes 20 and the conductor wires 31. The liquid solder solidifies and becomes solid solder 4 as the temperature decreases, while the conductor wires 31 are pressed against the electrodes 20 by the heater chip 7.

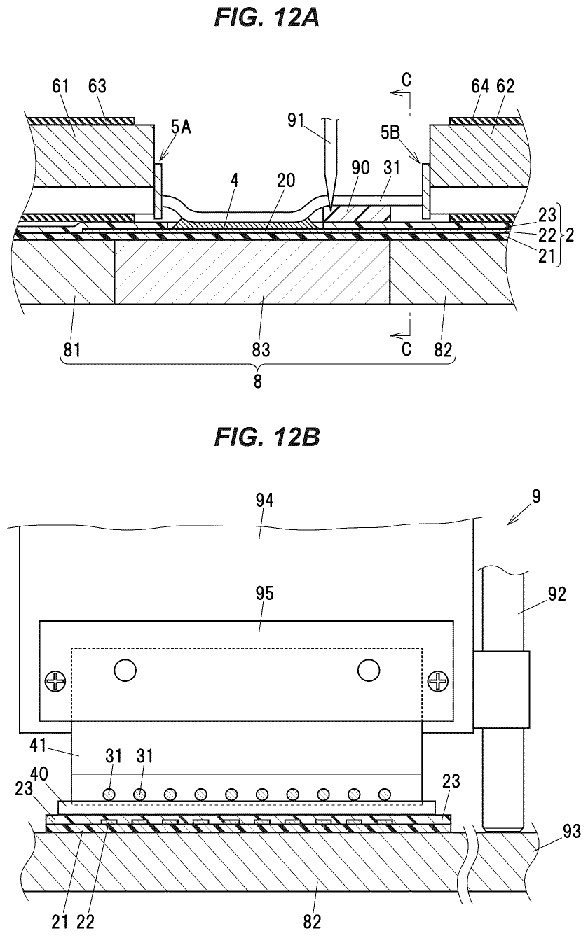

FIG. 12A is an explanatory diagram of the removal step. In the removal step, the plurality of conductor wires 31 are placed between the protective material 90 and the blade tool 91, and the blade tool 91 is pressed against the protective material 90 to cut the plurality of conductor wires 31 collectively. As a result, as shown in FIG. 1A and FIG. 1B, the tip 311 of each of the plurality of conductor wires 31 becomes curved so that it is raised from the substrate 2.

FIG. 12B is an explanatory diagram showing a moving member 92 that moves with the blade tool 91 against the substrate 2, a contact member 93 that the moving member 92 contacts when the blade tool 91 bites into the protective material 90, a support member 94 that supports the blade tool 91 and moves in a direction perpendicular to the substrate 2, and a pincer member 95 that pinches and holds the blade tool 91 between itself and the support member 94.

The moving member 92 and the contact member 93 are used in the removal step, in which the moving member 92 regulates the movement of the blade tool 91 toward the substrate 2 by contacting the contact member 93. Specifically, the position of the moving member 92 relative to the blade tool 91 is adjusted so that the moving member 92 contacts the contact member 93 when the tool 91 bites into the protective material 90 in a predetermined amount (e.g., 10 μm), then the moving member 92 regulates further movement of the blade tool 91 by contacting the contact member 93. A part of the support base 8 can be used as the contact member 93, for example, but the contact member 93 may be a separated body from the support base 8.

To adjust the position of the moving member 92, for example, a micrometer head can be used, in which a spindle is moved forward and backward by the rotation of a thimble. In this case, the spindle of the micrometer head, or a member that moves axially with the spindle, is used as the moving member 92, and the position of the moving member 92 is adjusted each time the blade tool 91 is replaced. Therefore, when a used blade tool 91 is removed from the support member 94 and replaced with a new one, the cutting position of the blade tool 91 can be set to an appropriate position where the plurality of conductor wires 31 can be cut securely and without damaging the substrate 2, even if the position of the blade tool 91 is slightly displaced with respect to the support member 94.

After cutting the plurality of conductor wires 31 in the removal step, portions of the conductor wires 31 from the cutting position to the wire tips and the second portions 322 of the insulators 32, are removed from the substrate 2 together with the comb-shaped element 5B and the support 62, and the tape 63 which is securing the first portions 321 of the insulators 32 to the support 61 with the conductor wires 31 inside, is removed. In this way, an electronic device 1 having the connection structure for connecting the plurality of conductor wires 31 to the plurality of electrodes 20 on the substrate 2 as shown in FIG. 1A can be obtained.

### (Functions and Effects of the Embodiment)

According to the embodiment described above, the following effects (1) through (7) can be obtained.

(1) Since the soldering step is performed with tension applied to the plurality of conductor wires 31, the plurality of conductor wires 31 form straight lines on the electrodes 20 during the soldering step, and the conductor wires 31 can be connected to the electrodes 20 with a sufficient length corresponding to the length of the electrodes 20.

(2) Since it is a frictional force between the conductor wires 31 and the insulators 32 that applies the tension to the conductor wires 31, the tension is not applied to the conductor wires 31 excessively. Thus, even when ultrafine conductor wires 31 (with a conductor diameter of 0.10 mm or less) are used, the breaking of the conductor wires 31 due to the tension can be suppressed.

(3) In the soldering step, because a single heater chip 7 can solder the plurality of conductor wires 31 collectively, the time required for the soldering step can be shortened.

(4) Since the plurality of conductor wires 31 are placed on the plurality of electrodes 20 on the substrate 2 in a state where the plurality of wires 3 has been half stripped by using a pair of comb-shaped elements 5A, 5B, the half-stripping step and the placing step can be easily performed. In addition, the work steps and the manufacturing time can be reduced, for example, compared to the case where the plurality of wires 3 that have been half stripped, are removed from the half-stripping jig 5 and placed on the substrate 2.

(5) In the half-stripping step, the slits 50 of the comb-shaped elements 5A, 5B are engaged with the conductor wires 31 between the first portions 321 and the second portions 322 of the insulators 32, which are separated by the laser beam irradiation. In this way, the comb-shaped elements 5A, 5B can be placed between the first portions 321 and the second portions 322 of the insulators 32, while avoiding the conductor wires 31 from being damaged. In other words, if the insulators 32 are cut by the blade tool formed on the comb-shaped elements 5A, 5B, the conductor wires 31 may be damaged by the blade tool, but by separating the insulators 32 into the first portions 321 and the second portions 322 by laser beam irradiation as in the present embodiment, the conductor wires 31 can be prevented from being damaged.

(6) In the removal step, the protective material 90 is placed between the plurality of conductor wires 31, and the moving member 92 regulates the movement of the blade tool 91 toward the substrate 2 by contacting the contact member 93, so that the plurality of conductor wires 31 can be securely cut collectively without damaging the substrate 2.

(7) The tip 311 of the conductor wire 31 is curved in such a way that it is raised from the substrate 2, allowing soldering to be performed with the conductor wire 31 in a tensioned state pressed against the electrodes 20. In addition, the tip surface 311a of the conductor wire 31 is located on the coverlay 23 of the substrate 2, allowing the extra length portion of the conductor wire 31 to be cut and removed on the coverlay 23, ensuring that the wiring patterns of the electrodes 20 and the conductive layer 22 are not damaged.

### Modified Example

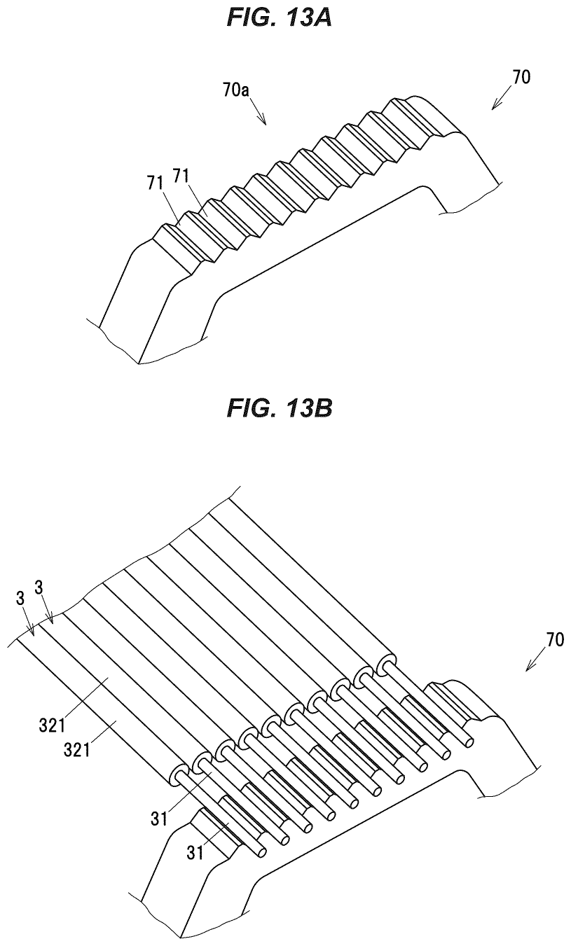

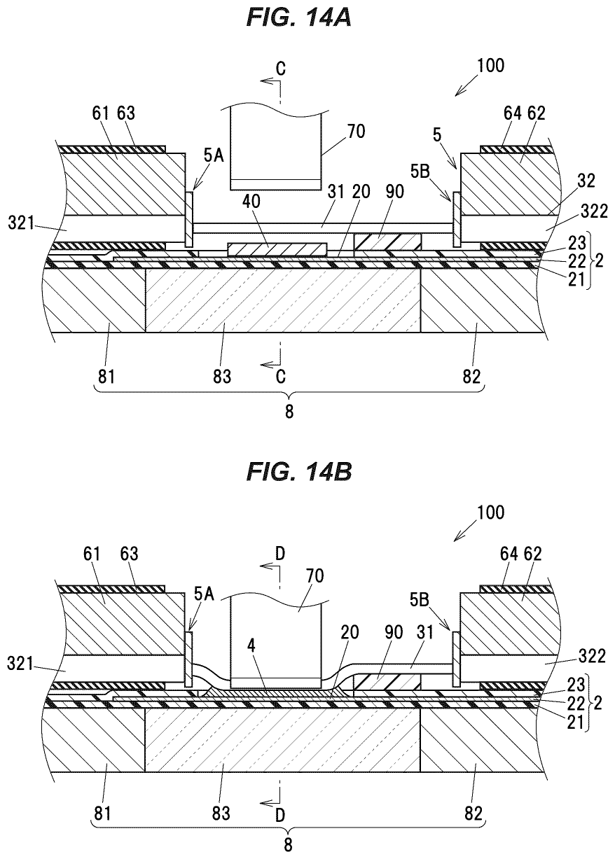

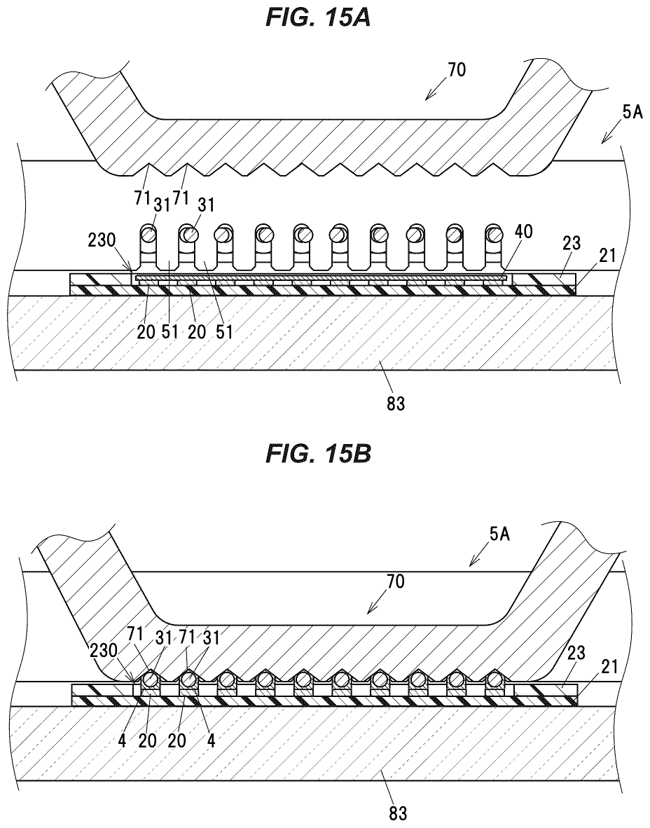

FIG. 13A is a perspective view showing the heater chip 70 as a heating element according to a modified example. FIG. 13B is a perspective view showing the heater chip 70 and the plurality of wires 3. FIG. 14A and FIG. 14B are configuration diagrams showing the soldering step using the heater chip 70 and the connection device 100 having the heater chip 70. FIG. 15A is a cross-sectional view taken along the line C-C of FIG. 14A, and FIG. 15B is a cross-sectional view taken along the line D-D of FIG. 14B. The connection device 100 is configured in the same way as the connection device 10 according to the above embodiment, except for having the heater chip 70 instead of the heater chip 7 according to the above embodiment.

The heater chip 70 has a plurality of V-grooves 71 formed on an opposite surface 70a facing the substrate 2. In the soldering step using the heater chip 70, the V-grooves 71 guide the conductor wires 31 to the positions facing the electrodes 20 at their centers in the width direction, respectively. Each V-groove 71 extends in a straight line along the longitudinal direction of the electric wire 3, and when the conductor wires 31 are accommodated in the V-grooves 71, the conductor wires 31 are parallel to the longitudinal direction of the electrodes 20.

As shown in FIG. 14A, the heater chip 70 is placed above the conductor wires 31 that are in a tensioned state in the placing step. The heater chip 70 is then moved toward the substrate 2, and each of the plurality of conductor wires 31 is sandwiched between the heater chip 70 and the substrate 2 while being accommodated in the plurality of V-grooves 71 of the heater chip 70. The heat from the heater chip 70 melts the solder foil 40, and the plurality of conductor wires 31 are soldered to the plurality of electrodes 20.

According to the connection method using the heater chip 70 in the modified example, the aforementioned effects (1) through (7) can be obtained. At the same time, even if waviness occurs in the conductor wire 31, the conductor wires 31 are soldered to the electrodes 20 with the waviness corrected by the V-grooves 71 of the heater chip 70, and therefore, the conductor wires 31 can be soldered more securely. In other words, the conductor wires 31 are given tension by the frictional force with the insulator 32 as described above, but this tension is not necessarily strong enough to straighten the conductor wires 31 in the exposed part in the half-stripping step, and the conductor wires 31 in the exposed part may be wavy slightly. However, by using the heater chip 70 according to the modified example, even the slight waviness can be removed for soldering.

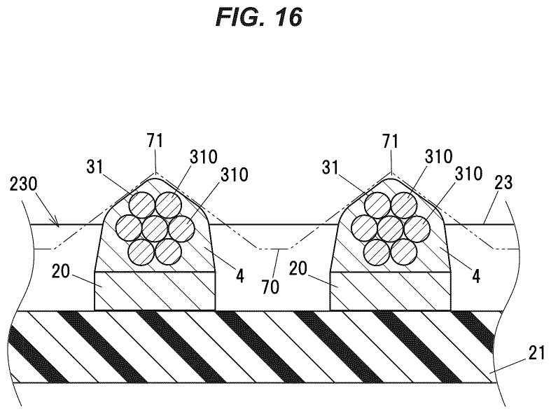

According to the modified example, the soldering step can be performed suppressing the amount of crush of the conductor wires 31 when the heater chip 70 presses the conductor wires 31 toward the substrate 2. FIG. 16 is a cross-sectional view of the conductor wires 31 soldered to the electrodes 20 of the substrate 2. In FIG. 16, the outline of the heater chip 70 is shown as a virtual line (two dotted lines). As shown in FIG. 16, the conductor wires 31 pressed toward the substrate 2 by the heater chip 70 are soldered to the electrodes 20, while a plurality of strands 310 twisted together is led to the deepest part of the V-grooves 71. In other words, if the heater chip has a flat surface facing the substrate 2 and presses the conductor wires 31 onto the electrodes 20, there is a risk of flattening the conductor wires 31 with the plurality of strands 310 lined up in the width direction of the electrodes 20, which results in narrowing the distance between the adjacent conductor wires 31. However, by using the heater chip 70 with the V-grooves 71 formed, it is possible to solder the conductor wires 31 to near the center positions of the electrodes 20 in the width direction respectively, while suppressing the deformation of the conductor wires 31.

### (Summary of the Embodiment)

Next, technical ideas understood from the above embodiment will be described with reference to the reference numerals and the like used in the embodiment. However, each reference numeral in the following description does not limit the constituent elements in the scope of claims to the members and the like specifically shown in the embodiments.

According to the first feature, a conductor wire connection method for connecting a conductor wire 31 to an electrode 20 that is formed on a substrate 2 includes a step of placing the conductor wire 31 on the electrode 20 while tension is applied to the conductor wire 31, and a step of soldering the conductor wire 31 to the electrode 20 while the conductor wire 31 is pressed toward the substrate 2 by a heating element (heater chip 7, 70).

According to the second feature, in the conductor wire connection method as described by the first feature, in the placing step, the conductor wire 31 is covered by an insulator 32 on both sides in a longitudinal direction at a portion to be soldered to the electrode 20, and a frictional force between the conductor wire 31 and the insulator 32 provides the tension to the conductor wire 31.

According to the third feature, in the conductor wire connection method as described by the second feature, in the placing step, a plurality of the conductor wires 31 in a tensioned state are placed on a plurality of the electrodes 20 formed on the substrate 2, respectively, and wherein, in the soldering step, the plurality of the conductor wires 31 are pressed against the plurality of the electrodes 20 and soldered collectively by the heating element (heater chip 7, 70).

According to the fourth feature, the conductor wire connection method as described by the third feature further includes a step of half-stripping a plurality of the insulators 32 covering the plurality of the conductor wires 31 respectively prior to the placing step, wherein, in the half-stripping step, a pair of comb-shaped elements 5A, 5B having a plurality of slits 50 formed with a width W larger than a diameter (conductor diameter) D₁ of the conductor wire 31 and smaller than an outer diameter D₂ of the insulator 32 is used, and wherein the pair of comb-shaped elements 5A, 5B are separated in the longitudinal direction of the conductor wires 31 to expose the conductor wires 31 between the pair of comb-shaped elements 5A, 5B, in a state where the plurality of the conductor wires 31 are inserted into the plurality of slits 50 of the pair of comb-shaped elements 5A, 5B respectively.

According to the fifth feature, in the conductor wire connection method as described by the fourth feature, in the half-stripping step, after the plurality of the conductor wires 31 in a stripped area formed by removing portions of the plurality of the insulators 32 by laser irradiation, are inserted into the plurality of slits 50 of the pair of comb-shaped elements 5A, 5B, the pair of comb-shaped elements 5A, 5B are separated from each other.

According to the sixth feature, in the conductor wire connection method as described by the fourth or fifth feature, in the placing step, the plurality of the conductor wires 31 are placed on the plurality of the electrodes 20 in a tensioned state between the pair of comb-shaped elements 5A, 5B.

According to the seventh feature, in the conductor wire connection method as described by the second feature, further includes a step of removing the conductor wires 31 by cutting the conductor wires 31 at a tip side from portions soldered to the electrodes 20 after the soldering step, wherein, in the placing step, a protective material 90 is placed between the conductor wires 31 and the substrate 2, and in the removing step, the conductor wires 31 are placed between the protective material 90 and a blade tool 91, and the blade tool 91 is pressed against the protective material 90 to cut the conductor wires 31.

According to the eighth feature, in the conductor wire connection method as described by the seventh feature, in the removing step, a moving member 92 that moves with the blade tool 91 against the substrate 2 and a contact member 93 that the moving member 92 contacts when the blade tool 91 bites into the protective material 92 are used, and wherein the moving member 92 regulates movement of the blade tool 91 by contacting the contact member 93.

According to the ninth feature, in the conductor wire connection method as described by any one of the first to fifth features, V-grooves 71 are formed on an opposite surface 70a of the heating element (heater chip 70) facing the substrate 2, and wherein the V-grooves 71 guide the conductor wires 31 to positions facing the electrodes 20 during the soldering step.

According to the tenth feature, a half-stripping jig 5 for collectively half-stripping a plurality of insulated wires (electric wire 3) each having a conductor wire 31 coated with an insulator 32 includes a pair of comb-shaped elements 5A, 5B with a plurality of slits 50, wherein a width W of each of the plurality of slits 50 is larger than a diameter D₁ of the conductor wire 31 and smaller than an outer diameter D₂ of the insulator 32, and wherein the conductor wires 31 are exposed between the pair of comb-shaped elements 5A, 5B by separating the pair of comb-shaped elements 5A, 5B along a longitudinal direction of the plurality of conductor wires 31, in a state where the conductor wires 31 are inserted into the plurality of slits 50 respectively.

According to the eleventh feature, a connection device 10, 100 includes the half-stripping jig 5 as described by the tenth feature, and a heating element (heater chip 7, 70) that presses and solders a plurality of the conductor wires 31 inserted between the pair of comb-shaped elements 5A, 5B to a plurality of the electrodes 20 respectively.

According to the twelfth feature, in the connection device 100 as described by the eleventh feature, a plurality of V-grooves 71 are formed in the heating element (heater chip 7, 70) to guide the plurality of conductor wires 31 to positions facing the plurality of electrodes 20 respectively.

According to the thirteenth feature, an electronic device 1 includes a substrate 2 in which a plurality of electrodes 20 are formed and a plurality of conductor wires 31 are soldered to the plurality of electrodes 20 respectively, wherein each tip 311 of the plurality of conductor wires 31 is curved so that it is raised from the substrate 2.

According to the fourteenth feature, in the electronic device 1 as described by the thirteenth feature, wherein each tip surface 311a of the plurality of conductor wires 31 is located on a coverlay 23 of the substrate 2.

The above description of the embodiments of the present invention does not limit the invention to the scope of the claims. It should also be noted that not all of the combinations of features described in the embodiments are essential to the means to solve the problems of the invention. Additionally, in the above embodiment, the case in which the electric wire 3 consists of the conductor wire 31 and the insulator 32 was described, but the present invention may be applied to a coaxial wire having an outer conductor further on the periphery of the insulator 32 of an insulated covered wire consisting of the conductor wire 31 and the insulator 32. In this case, the insulator 32 is placed between the conductor wire 31 as the center conductor and the outer conductor.

1. A conductor wire connection method for connecting a conductor wire to an electrode that is formed on a substrate, comprising:
placing the conductor wire on the electrode while tension is applied to the conductor wire; and
soldering the conductor wire to the electrode while the conductor wire is pressed toward the substrate by a heating element.

2. The conductor wire connection method according to claim 1, wherein in the placing, the conductor wire is covered by an insulator on both sides in a longitudinal direction at a portion to be soldered to the electrode, and wherein a frictional force between the conductor wire and the insulator provides the tension to the conductor wire.

3. The conductor wire connection method according to claim 2, wherein, in the placing, a plurality of the conductor wires in a tensioned state are placed on a plurality of the electrodes formed on the substrate, respectively, and wherein, in the soldering, the plurality of the conductor wires are pressed against the plurality of the electrodes and soldered collectively by the heating element.

4. The conductor wire connection method according to claim 3, further comprising:
half-stripping a plurality of the insulators covering the plurality of the conductor wires respectively prior to the placing, wherein, in the half-stripping, a pair of comb-shaped elements having a plurality of slits formed with a width larger than a diameter of the conductor wire and smaller than an outer diameter of the insulator is used, and wherein the pair of comb-shaped elements are separated in the longitudinal direction of the conductor wires to expose the conductor wires between the pair of comb-shaped elements, in a state where the plurality of the conductor wires are inserted into the plurality of slits of the pair of comb-shaped elements respectively.

5. The conductor wire connection method according to claim 4, wherein, in the half-stripping, after the plurality of the conductor wires in a stripped area formed by removing portions of the plurality of the insulators by laser irradiation, are inserted into the plurality of slits of the pair of comb-shaped elements, the pair of comb-shaped elements are separated from each other.

6. The conductor wire connection method according to claim 4, wherein, in the placing, the plurality of the conductor wires are placed on the plurality of the electrodes in a tensioned state between the pair of comb-shaped elements.

7. The conductor wire connection method according to claim 2, further comprising:
removing the conductor wires by cutting the conductor wires at a tip side from portions soldered to the electrodes after the soldering,
wherein, in the placing, a protective material is placed between the conductor wires and the substrate, and
wherein, in the removing, the conductor wires are placed between the protective material and a blade tool, and the blade tool is pressed against the protective material to cut the conductor wires.

8. The conductor wire connection method according to claim 7, wherein, in the removing, a moving member that moves with the blade tool against the substrate and a contact member that the moving member contacts when the blade tool bites into the protective material are used, and wherein the moving member regulates movement of the blade tool by contacting the contact member.

9. The conductor wire connection method according to claim 1, wherein V-grooves are formed on an opposite surface of the heating element facing the substrate, and wherein the V-grooves guide the conductor wires to positions facing the electrodes during the soldering.

10. A half-stripping jig for collectively half-stripping a plurality of insulated wires each having a conductor wire coated with an insulator, comprising:
a pair of comb-shaped elements with a plurality of slits,
wherein a width of each of the plurality of slits is larger than a diameter of the conductor wire and smaller than an outer diameter of the insulator, and
wherein the conductor wires are exposed between the pair of comb-shaped elements by separating the pair of comb-shaped elements along a longitudinal direction of the plurality of conductor wires, in a state where the conductor wires are inserted into the plurality of slits respectively.

11. A connection device, comprising:
the half-stripping jig according to claim 10; and
a heating element that presses and solders a plurality of the conductor wires inserted between the pair of comb-shaped elements to a plurality of the electrodes respectively.

12. The connection device according to claim 11, wherein a plurality of V-grooves are formed in the heating element to guide the plurality of conductor wires to positions facing the plurality of electrodes respectively.

13. An electronic device, comprising:
a substrate in which a plurality of electrodes are formed and a plurality of conductor wires are soldered to the plurality of electrodes respectively,
wherein each tip of the plurality of conductor wires is curved so that it is raised from the substrate.

14. The electronic device according to claim 13, wherein each tip surface of the plurality of conductor wires is located on a coverlay of the substrate.
